(19) United States
(12) Patent Application Publication
(10) Pub. No.: US 2024/0332634 A1
(43) Pub. Date: Oct. 3, 2024

(54) CYLINDRICAL SOLID-STATE BATTERY, BATTERY MODULE, AND METHOD OF MANUFACTURING CYLINDRICAL SOLID-STATE BATTERY

(71) Applicant: HONDA MOTOR CO., LTD., Tokyo (JP)

(72) Inventors: Seiichiro ISHIKAWA, Saitama (JP); Isao OHASHI, Tokyo (JP)

(21) Appl. No.: 18/590,967

(22) Filed: Feb. 29, 2024

(30) Foreign Application Priority Data
Mar. 29, 2023 (CN) 202310320797.2

(51) Int. Cl. H01M 10/0587; H01M 50/107; H01M 50/477

(52) U.S. Cl. CPC H01M 10/0587; H01M 50/107; H01M 50/477

(57) ABSTRACT

Provided is a technique for enabling a cylindrical battery to exert a sufficient restraining force even in a case where a volume variation occurs. A cylindrical solid-state battery 10 includes: a wound electrode group 11 including a wound sheet-shaped electrode laminate that has a positive electrode and a negative electrode laminated with a solid electrolyte layer interposed therebetween; and a restraint member 15 disposed inside the wound electrode group 11 and having a bag shape with a container portion 17 in which a fluid is contained. The restraint member 15 pressurizes the wound electrode group 11 from inside.

This application is based on and claims the benefit of priority from Chinese Patent Application No. CN202310320797.2, filed on 29 Mar. 2023, the content of which is incorporated herein by reference.

### BACKGROUND OF THE INVENTION

### Field of the Invention

The present invention relates to a cylindrical solid-state battery, a battery module, and a method of manufacturing a cylindrical solid-state battery.

### Related Art

There are known cylindrical solid-state batteries. This type of technique is disclosed in, for example, PCT International Publication No. WO2018/168549. PCT International Publication No. WO2018/168549 relates to an all-solid secondary battery including a battery element member having a current collector, a solid electrolyte layer, and a positive electrode active material layer, a core shaft having the battery element member disposed around a side surface thereof, and a battery outer package in which the battery element member and the core shaft are housed. PCT International Publication No. WO2018/168549 discloses that the battery element member is formed into a cylindrical shape in a manufacturing process of the all-solid secondary battery.
Patent Document 1: PCT International Publication No. WO2018/168549

### SUMMARY OF THE INVENTION

Meanwhile, it is necessary to exert a restraining force in order to integrally hold the components of a battery; but the exertion of such a restraining force requires a large structure capable of withstanding a load. For example, in a case where a restraining force of 1 MPa or greater is to be applied to a battery cell of a size of 500×100 mm, the structure has to withstand a load of 5 t or greater. In this respect, the cylindrical battery of the known art is excellent in load-bearing capacity. However, it is necessary to add a structure for absorbing a volume variation in order to enable restraint with a constant pressure. Although the cylindrical battery is excellent in load-bearing capacity, the structure thereof makes it difficult to apply a preload and to add a configuration for addressing a volume variation.

It is an object of the present invention to provide a technique for enabling a cylindrical battery to exert a sufficient restraining force even in a case where a volume variation occurs.

A first aspect of the present invention is directed to a cylindrical solid-state battery including: a wound electrode group including a wound sheet-shaped electrode laminate that has a positive electrode and a negative electrode laminated with a solid electrolyte layer interposed therebetween; and a restraint member disposed inside the wound electrode group and having a bag shape with a container portion in which a fluid is contained. The restraint member is configured to pressurize the wound electrode group from inside.

According to a second aspect of the present invention, in the cylindrical solid-state battery of the first aspect, the restraint member may be made of a stretchable material.

A third aspect of the present invention is directed to a battery module including: the cylindrical solid-state battery of the first or second aspect; and a pressure regulator configured to regulate an internal pressure in the restraint member by means of a fluid via a flow path that communicates with the container portion.

A fourth aspect of the present invention is directed to a cylindrical solid-state battery including: a wound electrode group including a wound sheet-shaped electrode laminate that has a positive electrode and a negative electrode laminated with a solid electrolyte layer interposed therebetween; and a restraint member disposed inside the wound electrode group. The restraint member is configured to pressurize the wound electrode group from inside.

According to a fifth aspect of the present invention, in the cylindrical solid-state battery of the fourth aspect, the restraint member may be in contact with a heat exchanger.

A sixth aspect of the present invention is directed to a method of manufacturing a cylindrical solid-state battery including a wound electrode group including a wound sheet-shaped electrode laminate that has a positive electrode and a negative electrode laminated with a solid electrolyte layer interposed therebetween. The method includes: disposing a shaft-shaped restraint member at a center; and pressurizing, toward the center, the wound electrode group positioned outside the restraint member that has been disposed, thereby causing the restraint member to pressurize the wound electrode group from inside.

The present invention provides a technique for enabling a cylindrical battery to exert a sufficient restraining force even in a case where a volume variation occurs.

### BRIEF DESCRIPTION OF THE DRAWINGS

FIG. 1 is a front view schematically illustrating a solid-state battery according to a first embodiment of the present invention;

FIG. 2 is a plan view schematically illustrating the solid-state battery according to the first embodiment of the present invention;

FIG. 3 is a cross-sectional view schematically illustrating the solid-state battery according to the first embodiment of the present invention;

FIG. 4 is a cross-sectional view schematically illustrating solid-state batteries constituting a battery module according to a second embodiment of the present invention;

FIG. 5 is a cross-sectional view schematically illustrating a solid-state battery constituting a battery module according to a third embodiment of the present invention;

FIG. 6 is a graph schematically illustrating a relationship between battery volume variation and stress in the third embodiment;

FIG. 7 is a plan view schematically illustrating a solid-state battery according to a modification; and

FIG. 8 is a cross-sectional view schematically illustrating the solid-state battery according to the modification.

### DETAILED DESCRIPTION OF THE INVENTION

Embodiments of the present disclosure will be described below in detail with reference to the drawings. In the description of the second and subsequent embodiments, the same components as those of the first embodiment are denoted by the same reference signs, and the description of the same components may be omitted.

### First Embodiment

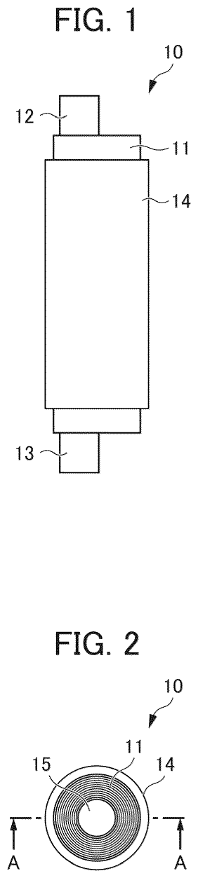

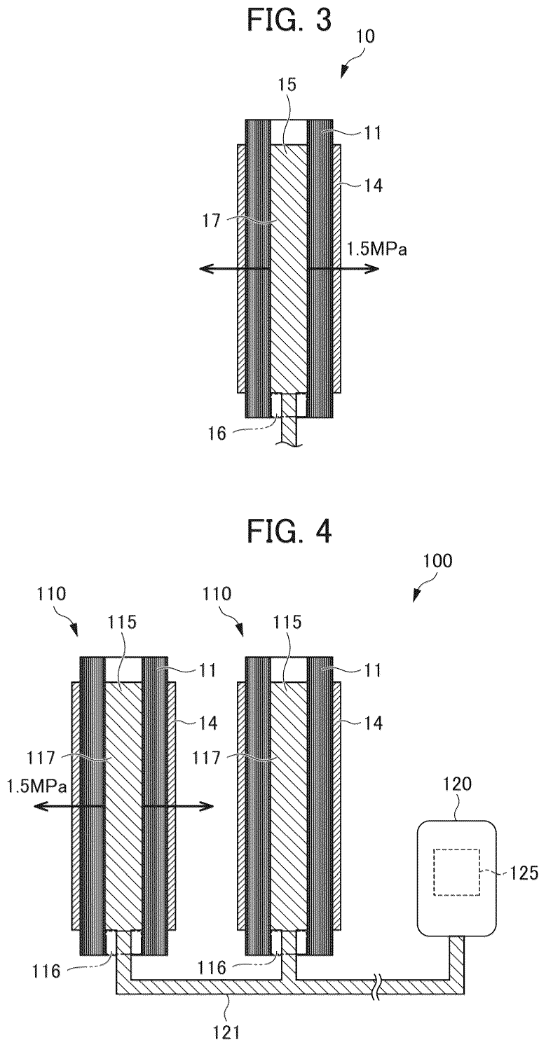

FIGS. 1 and 2 are respectively a front view and a cross-sectional view schematically illustrating a solid-state battery 10 according to the first embodiment of the present invention. FIG. 3 is a cross-sectional view taken along the line A-A in FIG. 2, and schematically illustrates the solid-state battery 10 according to the first embodiment of the present invention.

A plurality of the solid-state batteries 10 illustrated in FIGS. 1 to 3 are provided to constitute a battery module. The solid-state battery 10 according to the first embodiment includes a group 11 of wound electrodes (hereinafter referred to as the wound electrode group 11), a positive electrode tab 12, a negative electrode tab 13, an outer package member 14, a restraint member 15, and a lid member 16, and is formed into a cylindrical shape as a whole.

The wound electrode group 11 is formed by winding a sheet-shaped electrode laminate including a positive electrode and a negative electrode laminated with a solid electrolyte layer interposed therebetween. Any electrolyte may constitute the electrolyte layer as long as the electrolyte is a material capable of conducting lithium ions, and examples thereof include, but are not limited to, an oxide electrolyte, a sulfide electrolyte, and a molecular crystal electrolyte which is an electrolyte dissociated into crystals of an organic substance. The positive electrode and the negative electrode laminated to form the electrode laminate are each produced by forming an electrode mixture layer on an electrode current collector.

The positive electrode includes a positive electrode current collector having a positive electrode mixture layer formed thereon. Example of the positive electrode current collector include, but are not limited to, aluminum foil and the like. The positive electrode mixture layer contains a positive electrode active material, and may further contain a solid electrolyte, a conductive aid, a binder, and the like. Any positive electrode active material may be used as long as it can absorb and release lithium ions, and example thereof include, but are not limited to, LicoO₂, Li(Ni_{5/10}Co_{2/10}Mn_{3/10})O₂, Li(Ni_{6/10}Co_{2/10}Mn_{2/10})O₂, Li(Ni_{8/10}Co_{1/10}Mn_{1/10})O₂, Li(Ni_{0.8}Co_{0.15}Al_{0.05})O₂, Li(Ni_{1/6}Co_{4/6}Mn_{1/6})O₂, Li(Ni_{1/3}Co_{1/3}Mn_{1/3})O₂, LiCoO₄, LiMn₂O₄, LiNiO₂, LiFePO₄, lithium sulfide, sulfur, etc.

The negative electrode includes a negative electrode current collector having a negative electrode mixture layer formed thereon. Examples of the negative electrode current collector include, but are not limited to, copper foil and the like. The negative electrode mixture layer contains a negative electrode active material, and may further contain a solid electrolyte, a conductive aid, a binder, and the like. Any negative electrode active material may be used as long as it can absorb and release lithium ions, and examples thereof include, but are not limited to, metallic lithium, a lithium alloy, a metal oxide, a metal sulfide, a metal nitride, Si, SiO, a carbon material, etc. Examples of the carbon material include, but are not limited to, artificial graphite, natural graphite, hard carbon, soft carbon, etc.

It is only necessary for the electrode laminate to include a positive electrode and a negative electrode laminated with an electrolyte layer interposed therebetween, and the electrode laminate may include a plurality of positive electrodes and/or a plurality of negative electrodes. In the case of including a plurality of positive electrodes and/or a plurality of negative electrodes, the electrode laminate may have, for example, a laminate structure described as follows: “positive electrode/electrolyte/negative electrode/electrolyte/positive electrode”. In this case, the electrode laminate can be produced by way of roll pressing, for example.

The positive electrode tab 12 is formed to extend in a foil shape from the positive electrode current collector of the wound electrode group 11 toward one side (upper side in FIG. 1) in the axial direction of the cylindrical shape. The negative electrode tab 13 is formed to extend in a foil shape from the negative electrode current collector of the wound electrode group 11 toward the other side (lower side in FIG. 1) in the axial direction of the cylindrical shape.

The outer package member 14 is disposed adjacent to an outer peripheral side of the wound electrode group 11. The outer package member 14 is produced by forming a sheet-shaped material into a cylindrical shape. Any material may constitute the outer package member 14 as long as the material has conductivity, and examples thereof include, but are not limited to, a metal and the like. The outer package member 14 may be bonded to the outer peripheral side of the wound electrode group 11 with an adhesive or the like, or may be configured as an electrode current collector extending from an end of the outer peripheral side of the wound electrode group 11.

The restraint member 15 is a core shaft member disposed at the axial center of the solid-state battery 10, and exerts a restraining force for holding the components of the solid-state battery 10. The wound electrode group 11 is configured to surround the restraint member 15.

The restraint member 15 of the first embodiment is a bladder having a container portion 17 in which a fluid can be contained. The restraint member 15 is preferably made of a stretchable material such as rubber, etc. Examples of the material for forming the restraint member 15 include, but are not limited to, fluorine rubber, nitrile rubber, etc.

An inert gas is injected into the container portion 17 of the restraint member 15. The inert gas is, for example, N₂. When the inert gas is injected into the container portion 17, the restraint member 15 expands to increase in volume. As a result, the wound electrode group 11 that is wound around the restraint member 15 is pressed from inside to outside in the radial directions by the restraint member 15.

The lid member 16 is a cap having a sealing function of isolating the container portion 17 from the outside. The lid member 16 prevents the inert gas contained in the container portion 17 from leaking to the outside, thereby maintaining the pressurizing force exerted from inside by the restraint member 15. In the first embodiment, an amount of the inert gas to be injected, a tension to be applied at the time of winding the electrode group 11 and the outer package member 14, and the like are adjusted so that the restraint member 15 applies (restrains the components with) a constant pressure within the range of 1.5±0.5 MPa.

As described above, the solid-state battery 10 according to the first embodiment includes the wound electrode group 11 including a wound sheet-shaped electrode laminate that includes a positive electrode and a negative electrode laminated with a solid electrolyte layer interposed therebetween, and the restraint member 15 disposed inside the wound electrode group 11, made of a stretchable material, and having a bag shape in which a fluid is sealed. The restraint member 15 pressurizes the wound electrode group 11 from inside.

Thus, sealing a fluid in the restraint member 15, which is positioned inside the wound electrode group 11 and is expandable and contractible, causes the restraint member 15 to expand to increase in volume. Due to the increase in the volume, the restraint member 15 presses and restrains the wound electrode group 11 from inside, whereby a constant pressurizing force can be maintained even when a volume variation or the like occurs. Furthermore, since the restraint member 15 deforms in correspondence with the shape of the wound electrode group 11, the entire wound electrode group 11 can be restrained from inside with a uniform force, thereby enabling high-quality application of a constant pressure. Moreover, the pressurizing force can be precisely regulated by means of the amount of the fluid to be sealed.

### Second Embodiment

Next, a solid-state battery 110 and a battery module 100 according to the second embodiment will be described. FIG. 4 is a cross-sectional view schematically illustrating the solid-state batteries 110 constituting the battery module 100 according to the second embodiment of the present invention. The front view and the plan view of the solid-state battery 110 according to the second embodiment are the same as those of the first embodiment.

The battery module 100 according to the second embodiment includes a plurality of (two or more) solid-state batteries 110, an accumulator 120 serving as a pressure regulator, and a flow path 121 connecting the accumulator 120 and each of the plurality of solid-state batteries 110, and each solid-state battery 110 is formed into a cylindrical shape as a whole.

The solid-state battery 110 of the second embodiment includes a group 11 of wound electrodes (hereinafter referred to as the wound electrode group 11), a positive electrode tab 12, a negative electrode tab 13, an outer package member 14, a restraint member 115, and a connection member 116. The wound electrode group 11, the positive electrode tab 12, the negative electrode tab 13, and the outer package member 14 have the same or similar configurations to those of the first embodiment.

The restraint member 115 is a core shaft member disposed at the axial center of the solid-state battery 110, and exerts a restraining force for holding the components of the solid-state battery 110. The wound electrode group 11 is configured to surround the restraint member 15. The restraint member 115 is a bladder having a container portion 117 in which a fluid can be contained. As in the first embodiment, the restraint member 115 is preferably made of a stretchable material. An inert gas such as N₂ is injected into the container portion 117 of the restraint member 115.

The connection member 116 is a cap having a sealing function of isolating the container portion 117 from the outside, and also functions as a connection portion through which the flow path 121 communicates with the container portion 117.

The accumulator 120 is connected to each of the plurality of solid-state batteries 110 via the flow path 121. The accumulator 120 regulates the internal pressure in the container portion 117 of the restraint member 115 by moving a working fluid through the flow path 121. The working fluid is, for example, an incompressible liquid such as a solvent blended with a digestive agent.

The accumulator 120 includes a mechanism 125 for moving fluid. As the mechanism 125 for moving fluid, for example, a metal leaf spring or a constant force spiral spring may be used. The mechanism 125 for moving fluid is not limited to such a spring type mechanism, and may be of a piston type as needed. Furthermore, in the present embodiment, the accumulator 120 is configured to regulate the internal pressures in the restraint members 115 of the plurality of solid-state batteries 110. However, a configuration may be adopted in which accumulators 120 are disposed for the solid-state batteries 110 on a one-to-one basis.

The mechanism 125 for moving fluid operates to change the internal volume in response to a change in the pressure of the working fluid. This operation causes the working fluid to flow into and out of the container portions 117 of the restraint members 115, and the internal pressure in each restraint members 115 is maintained at a constant pressure. As a result, the wound electrode group 11 around the restraint member 115 is pressed in the radial directions from inside by the restraint member 115. In the second embodiment, the configuration of the accumulator 120, a tension to be applied at the time of winding the electrode group 11 and the outer package member 14, and the like are adjusted so that the restraint member 115 restrains the components with a constraint pressure within the range of 1.5±0.5 MPa. It can be said that the restraint members 115 and the accumulator 120 constitute a restraint structure for the solid-state batteries 110.

As described above, the battery module 100 according to the second embodiment includes the cylindrical solid-state batteries 110 and the accumulator 120 that functions as a pressure regulator. Each solid-state battery 110 includes the wound electrode group 11 including a wound sheet-shaped electrode laminate that includes a positive electrode and a negative electrode laminated with a solid electrolyte layer interposed therebetween, and the restraint member 115 disposed inside the wound electrode group 11, made of a stretchable material, and having a bag shape with the container portion 117 in which a fluid is contained. The accumulator 120 regulates the internal pressure in the restraint member 115 by means of a fluid via the flow path 121 communicating with the container portion 117. The restraint member 115 pressurizes the wound electrode group 11 from inside.

Thus, the restraint member 115, which is positioned inside the wound electrode group 11 and is expandable and contractible, expands due to the internal pressure therein and increases in volume. Due to the increase in the volume, the restraint member 115 presses and retains the wound electrode group 11 from inside. Since the restraint member 115 deforms in correspondence with the shape of the wound electrode group 11, the entire wound electrode group 11 can be restrained from inside with a uniform force, thereby enabling high-quality application of a constant pressure. Furthermore, in the present embodiment, since the internal pressure in the restraint members 115 is regulated by the accumulator 120, restraint with a constant pressure can be maintained even if the volumes of the solid-state batteries 110 change due to thermal expansion or the like during operation of the battery module 100.

### Third Embodiment

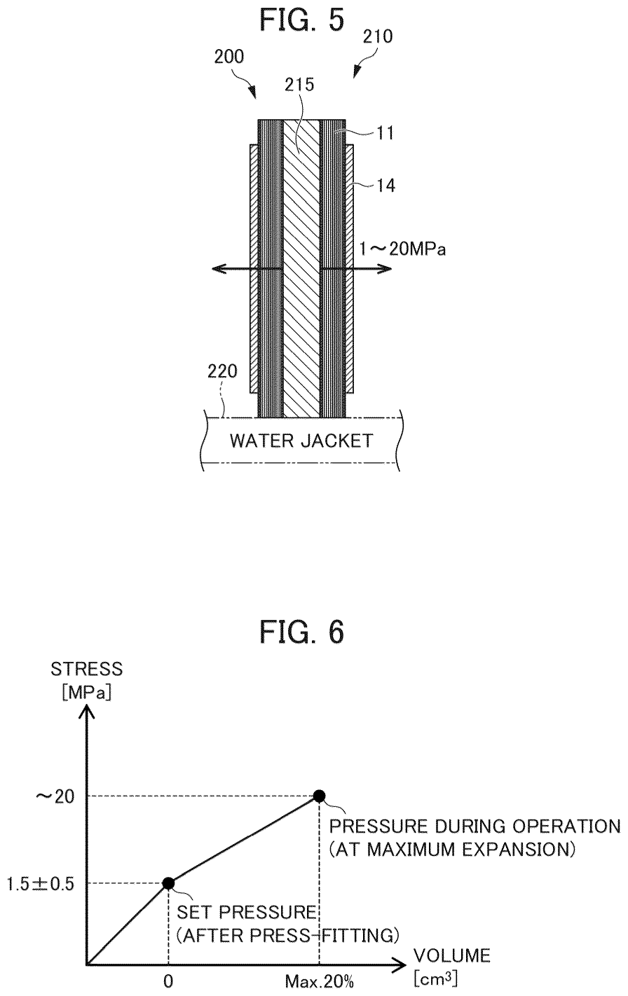

Next, a solid-state battery 210 according to a third embodiment will be described. FIG. 5 is a cross-sectional view schematically illustrating the solid-state battery 210 according to the third embodiment of the present invention. The front view and the plan view of the solid-state battery 210 according to the third embodiment are the same as those of the first embodiment.

A battery module 200 according to the third embodiment includes a plurality of the solid-state batteries 210 and a water jacket 220 serving as a heat exchanger. Although FIG. 5 illustrates only one solid-state battery 210, the battery module 200 includes the plurality of solid-state batteries 210.

The solid-state battery 210 of the third embodiment includes a group 11 of wound electrodes 11 (hereinafter referred to as the wound electrode group), a positive electrode tab 12, a negative electrode tab 13, an outer package member 14, and a restraint member 215, and is formed into a cylindrical shape as a whole. The wound electrode group 11, the positive electrode tab 12, the negative electrode tab 13, and the outer package member 14 have the same or similar configurations to those of the first embodiment.

The restraint member 215 of the third embodiment is a solid core shaft member and exerts a restraining force for holding the components of the solid-state battery 210. Examples of the material for the restraint member 215 include, but are not limited to, aluminum and the like. The restraint member 215 is configured such that its one end in the axial direction of the cylindrical solid-state battery 210 is in contact with the water jacket 220.

The water jacket 220 exchanges heat with a component in contact with the water jacket 220 by causing a fluid for heat exchange, such as water, to flow therethrough. The water jacket 220 may be provided for each battery module 200, or may be provided for each battery pack. The configuration in which the restraint member 215 is in contact with the water jacket 220 allows for heat exchange between the restraint member 215 and the water jacket 220. However, the present embodiment may be configured such that the restraint member is not in contact with the water jacket.

As described above, the cylindrical solid-state battery 210 of the third embodiment includes the wound electrode group 11 including a wound sheet-shaped electrode laminate that includes a positive electrode and a negative electrode laminated with a solid electrolyte layer interposed therebetween, and the restraint member 215 disposed inside the wound electrode group 11, and the restraint member 215 is in contact with the heat exchanger and pressurizes (restrains) the wound electrode group 11 from inside.

Thus, the wound electrode group 11 is pressed and restrained from inside by the restraint member 215 positioned inside the wound electrode group 11. Furthermore, the water jacket 220, which is in contact with the restraint member 215, makes it possible to efficiently transfer heat from the center portion (inside) of the solid-state battery 210. Even if volume expansion occurs during operation, the restraint member 215 positioned at the center of the solid-state battery 210 can reliably exert a pressurizing force (restraining force). Since the volume of the restraint member 215 itself has a relatively small influence, it can be said that constant-size restraint is performed.

Next, a method of manufacturing the solid-state battery 210 of the third embodiment will be described. First, the restraint member 215 as a core shaft member is disposed at the center. Next, a process is carried out in which the wound electrode group 11 and the outer package member 14 are pressurized toward the center at which the restraint member 215 is present, and are integrated together by way of bonding, for example. This process may be regarded as press-molding of the wound electrode group 11, etc. by using the restraint member 215.

A method of pressurizing toward the center includes, for example, forming the electrode group 11 into a cylindrical shape having a through hole at the center thereof, followed by press-fitting the restraint member 215 into the through hole. Alternatively, the method may include winding, under application of a tension, the electrode group 11 and the outer package member 14 around the restraint member 215. In both of the foregoing cases, the electrode group 11 and the outer package member 14 may be treated separately or may be integrated with each other, and then the restraint member 215 is press-fitted or the electrode group 11 and the outer package member 14 are wound around the restraint member 215.

FIG. 6 is a graph (battery volume variation-stress diagram) schematically illustrating a relationship between battery volume variation and stress in the third embodiment. As illustrated in FIG. 6, settings are made on the configuration of the restraint member 215 and the pressurizing force acting toward the center (e.g., a tension applied during the manufacturing process), such that restraint member 215 restrains the wound electrode group 11 with a constraint pressure within the range of 1.5±0.5 MPa in an initial state in which the wound electrode group 11 and the outer package member 14 are integrated with the restraint member 215.

When the volumes of the components of the solid-state battery 210 such as the restraint member 215 and the wound electrode group 11 increase due to thermal expansion or the like during operation of the battery module 200, the restraining force (pressurizing force for pressurizing the wound electrode group 11 outward from inside) exerted by the restraint member 215 also increases in accordance with the expansion of the volumes. In the present embodiment, settings are made on the shapes, the materials, the pressurizing force to be applied during the manufacturing process, and the like such that a maximum pressurizing force of 20 MPa is applied in a case where the volume increases by 20%. That is, the restraint member 215 is configured to pressurize the wound electrode group 11 from inside with a pressure in the range of 1.0 Mpa to 20.0 Mpa during the operation.

As described above, according to the method of manufacturing the solid-state battery 210 of the third embodiment, the cylindrical solid-state battery is manufactured which includes the wound electrode group including a wound sheet-shaped electrode laminate that has a positive electrode and a negative electrode laminated with a solid electrolyte layer interposed therebetween. The method of manufacturing the solid-state battery 210 includes disposing the shaft-shaped restraint member at the center, and pressurizing the wound electrode group 11 around the outer periphery of the restraint member 215 toward the center, thereby causing the restraint member 215 to pressurize the wound electrode group 11 from inside.

Thus, performing the process of pressing the wound electrode group 11 against the restraint member 215 positioned at the center or the process of causing the restraint member 215 to outwardly expand the wound electrode group 11 makes it possible to manufacture a solid-state battery having a configuration in which the wound electrode group 11 is pressurized and restrained from inside by the restraint member 215 positioned inside the wound electrode group 11. According to the configuration of the solid-state battery 210 of the present embodiment, even if volume expansion occurs during operation, the restraint member 215 positioned at the center of the solid-state battery 210 can reliably exert the pressurizing force (restraining force).

It should be noted that the present invention is not limited to the embodiments described above, and the embodiments described above may be appropriately modified without deviating from the spirit of the present invention.

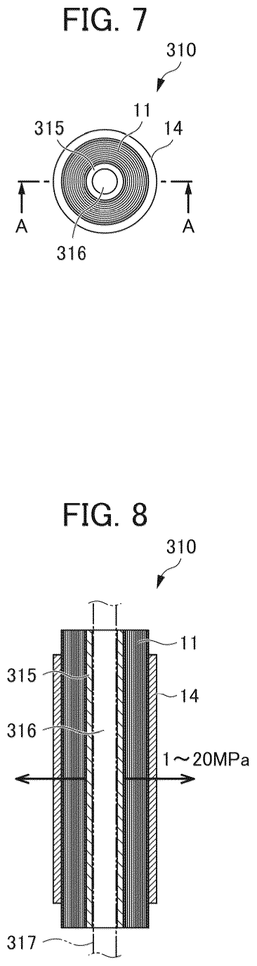

A configuration of a solid-state battery 310 according to a modification will be described with reference to FIGS. 7 and 8. FIG. 7 is a plan view schematically illustrating the solid-state battery 310 according to the modification. FIG. 8 is a cross-sectional view schematically illustrating the solid-state battery 310 according to the modification, taken along the line A-A in FIG. 7. The front view of the solid-state battery 310 according to the modification is the same as that of the first embodiment.

The solid-state battery 310 according to the modification illustrated in FIGS. 7 and 8 includes a group 11 of wound electrodes (hereinafter referred to as the wound electrode group 11), a positive electrode tab 12, a negative electrode tab 13, an outer package member 14, and a restraint member 315, and is formed into a cylindrical shape as a whole. The wound electrode group 11, the positive electrode tab 12, the negative electrode tab 13, and the outer package member 14 have the same or similar configurations to those of the embodiments described above.

The restraint member 315 of the modification is a hollow core shaft member. The restraint member 315 is disposed at a position coincident with the axial center of the cylindrical solid-state battery 310. Examples of the material for forming the restraint member 315 include, but are not limited to, aluminum, stainless steel, etc.

The restraint member 315 has a channel 316 formed in its hollow portion, and the channel 316 allows a fluid (heat carrier) that flows through the above-described water jacket or the like to flow therethrough. In this modification, both axial ends of the cylindrical solid-state battery 310 are connected to a flow path 317 for fluid. That is, the restraint member 315 forms part of the flow path 317, and this can be considered to be a state in which the restraint member 315 is in contact with a heat exchanger.

According to this modification, the wound electrode group 11 is pressurized and restrained from inside by the restraint member 315 positioned inside the wound electrode group 11. Furthermore, the fluid flowing through the interior of the restraint member 315 makes it possible to efficiently perform heat management from the central portion (inside) of the solid-state battery 210. Even if volume expansion occurs during operation, the restraint member 315 positioned at the center of the solid-state battery 310 reliably exerts a pressurizing force (restraining force). Also in this modification, since the volume of the restraint member 315 has a small influence, it can be said that constant-size restraint is performed. The battery of this modification can be manufactured by a method similar to that of the third embodiment.

### EXPLANATION OF REFERENCE NUMERALS

10, 110, 210, 310: Solid-state battery
11: Wound electrode group
12: Positive electrode tab
13: Negative electrode tab
14: Outer package member
15, 115, 215, 315: Restraint member
100, 200: Battery module
120: Accumulator (pressure regulator)
220 Water jacket (heat exchanger)

What is claimed is:

1. A cylindrical solid-state battery comprising:
a wound electrode group comprising a wound sheet-shaped electrode laminate that includes a positive electrode and a negative electrode laminated with a solid electrolyte layer interposed therebetween; and
a restraint member disposed inside the wound electrode group and having a bag shape with a container portion in which a fluid is contained,
the restraint member being configured to pressurize the wound electrode group from inside.

2. The cylindrical solid-state battery according to claim 1, wherein
the restraint member is made of a stretchable material.

3. A battery module comprising:
the cylindrical solid-state battery according to claim 1; and
a pressure regulator configured to regulate an internal pressure in the restraint member by means of a fluid via a flow path that communicates with the container portion.

4. A cylindrical solid-state battery comprising:
a wound electrode group comprising a wound sheet-shaped electrode laminate that includes a positive electrode and a negative electrode laminated with a solid electrolyte layer interposed therebetween; and
a restraint member disposed inside the wound electrode group,
the restraint member being configured to pressurize the wound electrode group from inside.

5. The cylindrical solid-state battery according to claim 4, wherein
the restraint member is in contact with a heat exchanger.

6. A method of manufacturing a cylindrical solid-state battery comprising a wound electrode group including a wound sheet-shaped electrode laminate that includes a positive electrode and a negative electrode laminated with a solid electrolyte layer interposed therebetween, the method comprising:
disposing a shaft-shaped restraint member at a center; and
pressurizing, toward the center, the wound electrode group positioned outside the restraint member that has been disposed, thereby causing the restraint member to pressurize the wound electrode group from inside.
